(19) United States
(12) Patent Application Publication
(10) Pub. No.: US 2013/0025694 A1
(43) Pub. Date: Jan. 31, 2013

(54) LIQUID DISTRIBUTION SYSTEM

(71) Applicant: Charles G. Lynn, Upper Marlboro, MD (US)

(72) Inventor: Charles G. Lynn, Upper Marlboro, MD (US)

(21) Appl. No.: 13/633,385

(22) Filed: Oct. 2, 2012

Related U.S. Application Data
(63) Continuation of application No. 12/461,584, filed on Aug. 17, 2009, now abandoned.

(51) Int. Cl. F17D 1/00

(52) U.S. Cl. 137/1

(57) ABSTRACT

The liquid distribution system includes a tank with a standpipe extending upwardly therefrom. A three-way pipefitting or the like is installed at the top of the standpipe. A selectively openable shutoff valve is below the three-way fitting. A flexible hose extends from another branch of the fitting. Another openable shutoff valve is installed between the fitting and the hose. Finally, a pump (electric, manual, hydraulic, etc.) is installed on the third branch of the fitting, with a meter, filter, hose, and dispensing nozzle installed downstream of the pump. The system is particularly useful in removing fuel from a motor vehicle or aircraft tank for transfer to another tank or its own system tank, or in dispensing fuel stored in the system tank to another vehicle tank. The system may, alternatively, be used for the transfer of other liquids from one tank or source to another.

This is a Continuation of application Ser. No. 12/461,584 filed Aug. 17, 2009. The disclosure of the prior application is hereby incorporated by reference herein in its entirety.

### BACKGROUND OF THE INVENTION

1. Field of the Invention

The present invention relates generally to storage and transfer systems for fuel and other liquids, and particularly to a liquid distribution system having a T or Y configuration that is capable of drawing liquid from either of two branches of the T or Y via an output pump in the third leg or branch of the T or Y.

2. Description of the Related Art

The need to transfer liquids from one container or vessel to another is nearly universal. Some examples of such need are found in the automotive field when it is necessary to defuel a vehicle or to draw fuel from one vehicle for use in another vehicle. This can occur in automotive salvage yards, where it is necessary to remove the fuel and other fluids from a vehicle before the vehicle is crushed for recycling. Authorities in various localities may also require that vehicles be defueled prior to their display in an indoor environment, e.g., a shopping mall, arena, etc., as for display at an auto show or the like. It is also often necessary in the aviation industry to defuel or remove some fuel from an aircraft for various reasons, e.g., fuel contamination, reduction of aircraft weight, fuel system maintenance, etc. The need to transfer liquids from one container to another is not limited to the automotive and aviation fields, and may extend to many other liquids and environmental fields as well.

While smaller containers may merely be tipped or inverted to drain their contents, this is clearly not feasible with larger containers, e.g., installed vehicle fuel tanks and the like. In such situations, one of two methods is generally employed to drain the contents: Either a drain in the bottom of the tank is accessed, or the contents are removed by siphoning or pumping out the liquid. The technique of draining the contents from a drain in the bottom of the tank is rather cumbersome in the case of most automotive vehicles, as most vehicles are not equipped with such a drain. The relatively small diameter fuel line requires a fair amount of time to drain the contents, particularly in the case of a relatively large tank with a large quantity of fuel. Aircraft tanks are universally equipped with drains, but these are primarily for the purpose of checking a fuel sample before flight and do not provide high fuel flow rates.

Moreover, there is the question of what to do with the fuel after it has been removed from the tank. Generally it is emptied into any handy makeshift container that might be available, with no consideration of contamination or mixing with other liquids. Not only does this waste the valuable fuel, but it requires additional expense for disposal of the liquid as hazardous waste.

Thus, a liquid distribution system solving the aforementioned problems is desired.

### SUMMARY OF THE INVENTION

The liquid distribution system includes a closed tank with a standpipe extending upwardly therefrom. A T or Y fitting, Le., a pipe fitting or the like having three legs or branches, is installed at the top of the standpipe, with a selectively openable shutoff valve disposed between the standpipe and the T or Y fitting. A flexible hose extends from another branch of the fitting, with another selectively openable shutoff valve between the fitting and the hose. A pump (manual, electric, hydraulic, etc.) is installed on the third branch of the fitting, with there preferably being a filter and meter installed downstream of the pump. An outlet hose or line with a dispensing nozzle is installed downstream of the pump, and of the filter and meter, if so installed.

The system may be installed on a tank that is in turn installed as a portable unit on or in a motor vehicle, or may alternatively be installed as a fixed, immobile station, if so desired. The pump may be operated electrically by electrical power from the motor vehicle or other electrical source as desired, or a manual or hydraulic pump may be provided as an alternative. The system is particularly useful for drawing fuel from one tank or container and transferring it to another tank or container or to the system tank, or transferring fuel from the system tank to another tank or container, as desired. While the liquid distribution system is particularly well suited for use in transferring fuel from one tank or container to another, the system may be used for the transfer of any liquid other than fuel from one tank or container to another or to or from the system tank, if so desired.

These and other features of the present invention will become readily apparent upon further review of the following specification and drawings.

### BRIEF DESCRIPTION OF THE DRAWINGS

FIG. 1 is a perspective view of a fuel distribution system according to the present invention, with the valves set to provide transfer of liquid from an external source to the system tank or to another tank.

FIG. 2 is a perspective view of an alternative embodiment of a fuel distribution system according to the present invention having a manual pump, shown with the valves set to draw liquid from the system tank.

FIG. 3 is an environmental perspective view of a liquid distribution system according to the present invention with the valves set in accordance with FIG. 1, shown being used to transfer fuel from the tank of a vehicle to the system tank.

FIG. 4 is an environmental perspective view of a liquid distribution system according to the present invention with the valves set in accordance with FIG. 2, shown being used to transfer fuel from the system tank to a vehicle tank.

Similar reference characters denote corresponding features consistently throughout the attached drawings.

### DETAILED DESCRIPTION OF THE PREFERRED EMBODIMENTS

The present invention is a liquid distribution system, for use in transferring or distributing various liquids as desired from one container or source to another. The system is particularly well suited for use. in transferring fuel from the tank of a vehicle to a storage tank integrated with the system, or to another tank or container as desired.

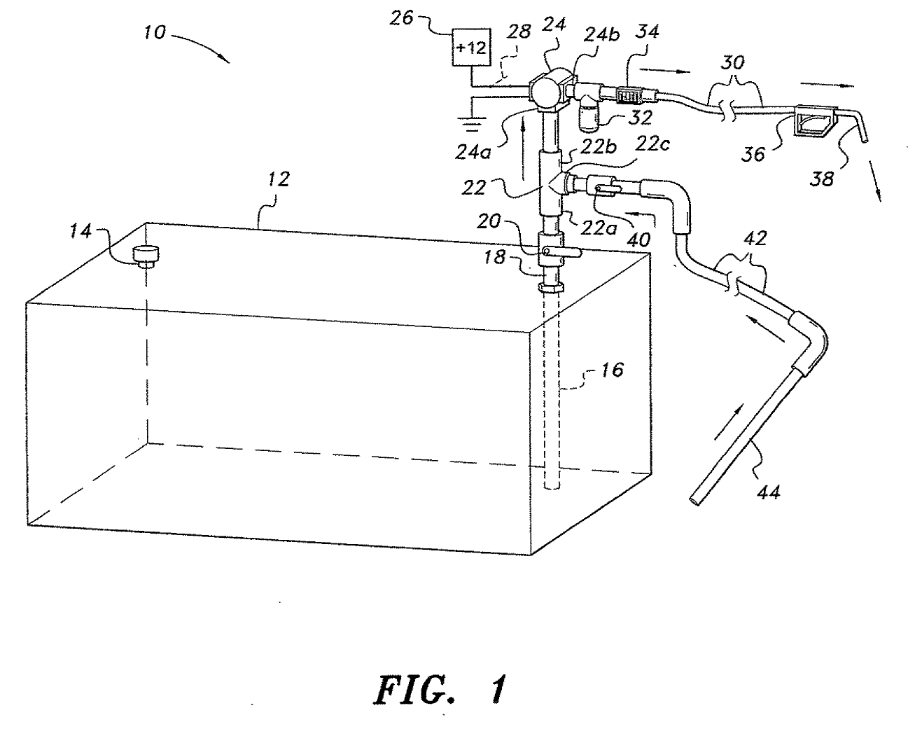

FIG. 1 is a perspective view of an exemplary first embodiment of the liquid distribution system 10, showing its valves set for drawing a liquid from an external source and transferring that liquid to another container or tank. The system 10 includes a closed liquid storage tank 12, i.e., the tank has a closed top with a normally closed or capped filler neck 14. Conventional vents, sediment drains, etc. may be provided as desired or required.

A standpipe 16 extends through the top of the tank 12 and downwardly therein, with the lower end of the standpipe 16 positioned close to the bottom of the tank in order to draw substantially all of the liquid therefrom if so desired. The outlet end 18 of the standpipe is disposed externally to the tank 12. A first shutoff valve 20 is installed upon the outlet end 18 of the standpipe 16. The valve 20 may be a manually actuated valve, as shown in the drawings, or may alternatively comprise a power actuated (e.g., electrically operated) valve, if so desired. The valve 20 is selectively opened or closed by the operator of the system 10 as desired, according to the liquid flow path desired.

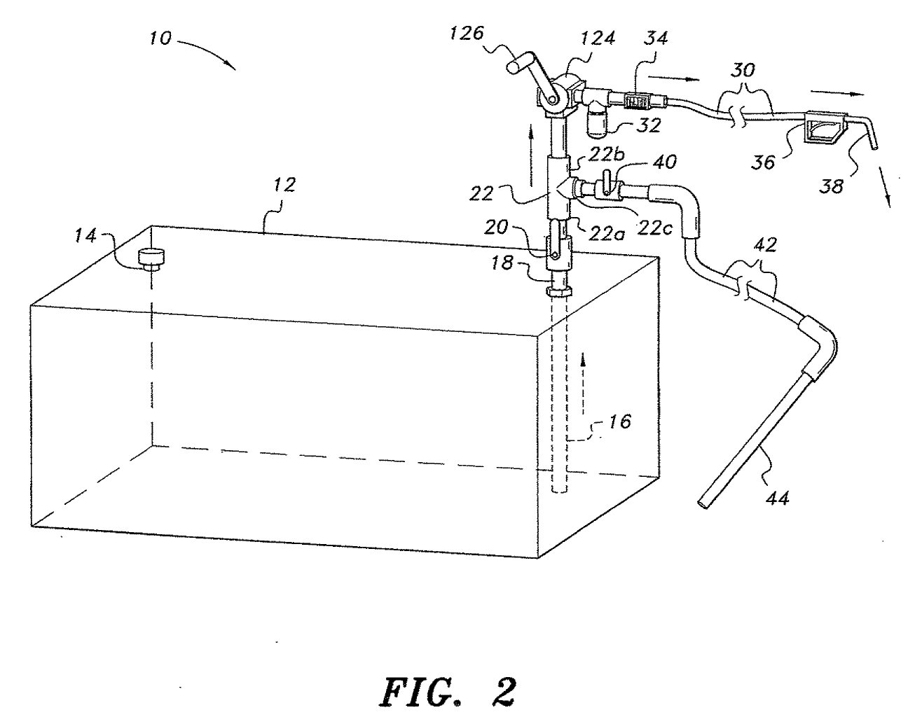

A three-way pipe fitting 22 or the like, i.e., a T or Y pipe fitting, etc., has a first leg 22a connected to the first shutoff valve 20. A pump 24 has its inlet side 24a connected to the second leg second leg 22b of the three-way fitting 22, with the pump 24 extending therefrom. The pump 24 of FIG. 1 is electrically powered, as indicated by the schematic showing of a twelve-volt power source 26 and electrical switch 28. It will be understood that other voltages may be used according to the rating of the pump 24, and that conventional electrical components, e.g., fuses, circuit breakers, relays or solenoids, etc., may be incorporated with the circuit as desired or required. The liquid distribution system 10 of FIG. 2 is identical to the system 10 of FIG. 1, with the exception of the pump. In the system of FIG. 2, the pump 124 is manually operated, as indicated by the handle 126.

A flexible dispensing line or hose 30 extends from the outlet side or port 24b of the pump 24. Preferably, a filter 32 is installed at the outlet side or port 24b of the pump 24, with a liquid quantity meter 34 also installed in the dispensing line 30. The filter 32 and meter 34 are preferably both installed in a rigid outlet pipe assembly extending from the immediately adjacent pump outlet 24b, with the flexible dispensing line 30 extending from the meter 34. The filter 32 and/or meter 34 may be deleted from the liquid distribution system 10 if so desired, but at least the filter 32 is desired in the installation, and the meter 34 is desired as well for fuel and/or other liquids having relatively high value or where tracking the quantity passing through the system 10 is important or critical. The flexible dispensing line or hose 30 has a distal or outlet end 36, with a selectively operable dispensing nozzle 38 extending therefrom.

The third leg 22c of the three-way fitting 22 includes a second selectively openable shutoff valve 40 connected thereto and extending therefrom. The shutoff valve 40 may be essentially identical to the shutoff valve 20 installed between the upper or outlet end 18 of the standpipe 16 and the first leg 22a of the three-way fitting 22. A flexible intake hose or line 42 extends from the shutoff valve 40, with the intake hose or line 40 preferably having a rigid extension 44 extending from the distal end thereof.

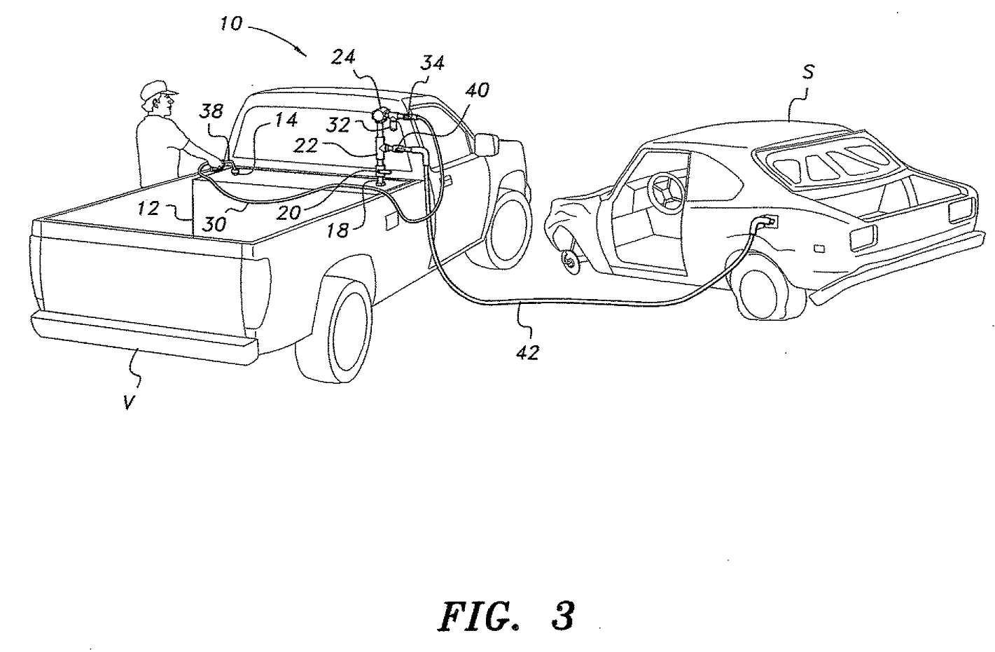

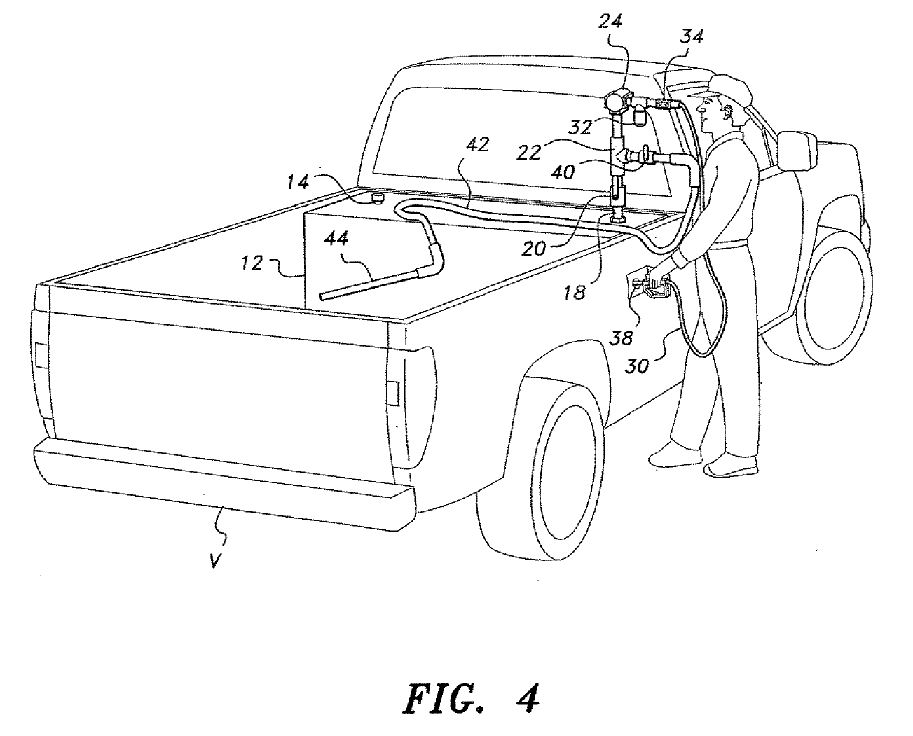

FIGS. 3 and 4 illustrate an exemplary installation of the liquid distribution system 10, wherein the system 10 is installed in a motor vehicle V (e.g., pickup truck, etc.) to provide mobility for the system. The operation illustrated in FIG. 3 of the drawings corresponds to the positions or settings of the first and second shutoff valves 20 and 40 shown in FIG. 1. In this example, the first shutoff valve 20 is closed, as indicated by its handle being positioned normal to the axis of the valve 20 and standpipe 16. The second shutoff valve 40 is open, as indicated by its handle being positioned parallel to the third leg 22c of the three-way fitting 22 and the extension from the valve 40.

In accordance with the above-described settings, no fuel or other liquid can be drawn from the storage tank 12 when the pump 24 is operating. Any fuel or other liquid transferred by the system 10 is drawn through the intake line 42 and open second valve 40, through the pump 24, thence through the filter 32 and meter 34 and out the dispensing line 30 and nozzle 38. In the example of FIG. 3, the rigid extension 44 of the intake line or hose 42 has been inserted into the fuel tank of a salvage vehicle S, with the open second valve 40 allowing fuel to be drawn from the tank of the salvage vehicle. The fuel passes through the pump 24, filter 32, meter 34, and dispensing line or hose 30, where it is dispensed from the nozzle 38. The flexible hose 30 allows the nozzle 38 to be positioned as desired, e.g., into the open filler neck 14 of the storage tank 12 of the system 10 to store the recovered fuel from the salvage vehicle S. It will be seen that the recovered fuel may be pumped directly into the fuel tank of another vehicle, if so desired, or into another storage container or tank as desired.

The first and second valve settings or positions shown in the environmental view shown in FIG. 4 correspond to those shown in FIG. 2, i.e., the first valve 20 between outlet end 18 of the standpipe and the three-way fitting 22 is open, and the second valve 40 between the inlet line 42 and the three-way fitting 22 is closed. When the valves 20 and 40 are set in this manner, the inlet line or hose 42 is closed, and no liquid can be drawn through the line 42. However, the standpipe to the bottom of the storage tank 12 is open. This allows the pump 24 to draw liquid, e.g., fuel, from the storage tank 12 and dispense the fuel through the filter 32, meter 34, and dispensing line 30, and out the dispensing nozzle 38. In the example illustrated in FIG. 4, fuel previously collected from another source(s) and gathered in the storage tank 12 is used to refuel the vehicle V in which the liquid distribution system 10 is installed. It will be seen that the vehicle V may be driven to any practicable location where fuel delivery may be needed, and the system 10 used to deliver fuel contained within the storage tank 12 as desired.

Accordingly, the liquid distribution system 10 in its various embodiments provides a versatile and useful means of handling fuel or other liquids that would otherwise be wasted. While the system 10 may be used to handle and distribute virtually any liquid, it is particularly useful for defueling salvage vehicles in auto recycling centers and the like, permitting the fuel in those vehicles to be used, rather than being disposed of as hazardous waste. The system 10 is also useful in the aviation industry, for defueling aircraft for various purposes (maintenance, weight reduction, etc.). Aviation fuel is notoriously expensive even in comparison to automotive and other fuels, and the present system allows such recovered fuel to be stored and used rather than being disposed of. The filtration system describe herein filters the fuel twice during use of the system, i.e., once when the fuel is pumped from the vehicle or aircraft tank and into the storage tank 12, and again when the fuel is pumped from the storage tank 12 for use in another vehicle or aircraft. Thus, any fuel dispensed from the system 10 is virtually assured of purity and will be safe for use in the desired system or environment.

It is to be understood that the present invention is not limited to the embodiments described above, but encompasses any and all embodiments within the scope of the following claims.

What is claimed is:

1. A method of transferring fuel, comprising:
placing an inlet of a fuel pump in fluid communication through a first conduit with fuel in a first fuel tank of a first vehicle containing fuel to be removed, the first fuel tank being a fuel tank configured to supply fuel to an engine of the first vehicle;
opening a first valve configured to open and close the first conduit;
closing a second valve configured to open and close a second conduit in fluid communication with an inlet of the fuel pump, the second conduit being in fluid communication with a second fuel tank; and
operating the pump to transfer fuel from the first fuel tank through the first conduit and out a nozzle that is in fluid communication with an outlet of the fluid pump.

2. The method according to claim 1, wherein the second fuel tank and fuel pump are carried by a second vehicle.

3. The method according to claim 1, further comprising:
transferring the fuel through the nozzle into the second fuel tank while the first valve is open and the second valve is closed.

4. The method according to claim 3, thereafter further comprising:
closing the first valve;
opening the second valve; and
operating the pump to transfer the fuel from the second fuel tank through the nozzle into a third fuel tank while the first valve is closed and the second valve is open.

5. The method according to claim 4, wherein the third fuel tank is a fuel tank of a second vehicle that is configured to supply fuel to an engine of the second vehicle.

6. The method according to claim 5, wherein the second fuel tank and fuel pump are carried by the second vehicle.

7. The method according to claim 5, wherein the second fuel tank and fuel pump are carried by a third vehicle.

8. The method according to claim 3, wherein the fuel delivered to the second fuel tank is available to the second inlet.

9. The method according to claim 1, further comprising:
transferring the fuel through the first conduit and out through the nozzle into a third fuel tank while the first valve is open and the second valve is closed.

10. The method according to claim 9, wherein the third fuel tank is in a second vehicle and is configured to supply fuel to an engine of the second vehicle.

11. The method according to claim 10, wherein the second fuel tank and fuel pump are carried by the second vehicle.

12. The method according to claim 10, wherein the second fuel tank and fuel pump are carried by a third vehicle.

13. The method according to claim 1, wherein the fuel is passed through a filter between the pump and the nozzle.

14. The method according to claim 4, wherein the fuel is passed through a filter between the pump and the nozzle.

15. The method according to claim 1, wherein the first vehicle is a car.

16. The method according to claim 1, wherein the first vehicle is an aircraft.

17. The method according to claim 1, wherein the fuel is transferred from the first fuel tank in conjunction with indoor display of the first vehicle.

18. The method according to claim 1, wherein the fuel is transferred from the first fuel tank in conjunction with salvage of the first vehicle.

19. The method according to claim 1, comprising manually operating the pump by way of a handle.

20. The method according to claim 1, comprising powering the pump electrically.
